(19) United States
(12) Patent Application Publication
(10) Pub. No.: US 2008/0145741 A1
(43) Pub. Date: Jun. 19, 2008

(54) Fuel battery cell and fuel cell stack

(76) Inventors: Kenji Kimura, Aichi-ken (JP); Hiroya Nakaji, Toyota-shi (JP); Junichi Shirahama, Toyota-shi (JP)

Correspondence Address: KENYON & KENYON LLP, 1500 K STREET N.W., SUITE 700, WASHINGTON, DC, 20005, US

(21) Appl. No.: 11/987,336

(22) Filed: Nov. 29, 2007

(30) Foreign Application Priority Data
Dec. 14, 2006 (JP) 2006-337539

(51) Int. Cl. H01M 8/02; H01M 8/24

(52) U.S. Cl. 429/34; 429/38

(57) ABSTRACT

A fuel battery cell which includes a fuel cell separator having a reaction gas passage, an inlet side reaction gas manifold which is in communication with an inlet portion of the reaction gas passage, and an outlet side reaction gas manifold which is in communication with an outlet portion of the reaction gas passage, wherein at least one of lower surfaces of the inlet side reaction gas manifold and the outlet side reaction gas manifold is inclined toward the reaction gas passage.

### PRIORITY INFORMATION

This application claims priority to Japanese Patent Application No. 2006-337539 filed on Dec. 14, 2006, which is incorporated herein by reference in its entirety.

### BACKGROUND

1. Technical Field

The present invention relates to a fuel battery cell and a fuel cell stack, and more particularly to a technology of a fuel cell separator used for a fuel battery cell and a fuel cell stack.

2. Related Art

Generally, the fuel battery cell has an electrolyte membrane, a pair of electrodes (an anode electrode and a cathode electrode), and a pair of fuel cell separators for holding the electrodes therebetween. When the fuel battery cell generates electricity using hydrogen gas as anode gas which is supplied to the anode electrode and oxygen gas as cathode gas which is supplied to the cathode electrode, a reaction is performed on the anode electrode side to produce hydrogen ions and electrons. The hydrogen ions reach the cathode electrode through the electrolyte membrane, and the electrons reach the cathode electrode through an external circuit. Meanwhile, the hydrogen ions, the electrons and the oxygen gas react on the cathode electrode side to produce water and to emit energy.

FIG. 1 is a schematic sectional view showing an example of a structure of a general fuel battery cell. As shown in FIG. 1, a fuel battery cell 1 has a membrane-electrode assembly 10 which is provided with an anode electrode and a cathode electrode so as to hold an electrolyte membrane therebetween, diffusion layers 11 which hold both sides of the membrane-electrode assembly 10 between them, an anode electrode side separator 12 and a cathode electrode side separator 14 as fuel cell separators for holding via resin frames 13, and gaskets 16 for sealing the fuel battery cells mutually. Hollow portions of the anode electrode side separator 12 and the cathode electrode side separator 14 formed on the side of the membrane-electrode assembly 10 form an anode gas passage 18a and a cathode gas passage 18b as a reaction gas passage, respectively. Also, the hollow portions of the anode electrode side separator 12 and the cathode electrode side separator 14 on the other side of the membrane-electrode assembly 10 become refrigerant passages for supplying a refrigerant such as cooling water.

FIG. 2(A) is a schematic top view of the anode electrode side separator 12 which is used for the fuel battery cell 1 shown in FIG. 1, and FIG. 2(B) is a schematic top view of the cathode electrode side separator 14 which is used for the fuel battery cell 1 shown in FIG. 1. As shown in FIGS. 2(A) and 2(B), the anode electrode side separator 12 and the cathode electrode side separator 14 each have the anode gas passage 18a or the cathode gas passage 18b as the reaction gas passages, an inlet side anode gas manifold 20a and an inlet side cathode gas manifold 20b as inlet side reaction gas manifolds, and an outlet side anode gas manifold 22a and an outlet side cathode gas manifold 22b as outlet side reaction gas manifolds. In addition, the anode electrode side separator 12 has an inlet side communication passage 26a which communicates an inlet portion 24a of the anode gas passage 18a with the inlet side anode gas manifold 20a, and an outlet side communication passage 30a which communicates an outlet portion 28a of the anode gas passage 18a with the outlet side anode gas manifold 22a. Similarly, the cathode electrode side separator 14 has an inlet side communication passage 26b which communicates an inlet portion 24b of the cathode gas passage 18b with the inlet side cathode gas manifold 20b, and an outlet side communication passage 30b which communicates an outlet portion 28b of the cathode gas passage 18b with the outlet side cathode gas manifold 22b.

As described above, water is produced when the fuel battery cell generates electricity. The produced water is drained from the anode electrode side separator 12 or the cathode electrode side fuel cell separator 14 to the outside of the fuel battery cell system. An example of a flow of the water drained from the cathode electrode side separator 14 is described below specifically.

The water produced when electricity is generated is drained from the inlet side cathode gas manifold 20b or the outlet side cathode gas manifold 22b to the outside of the fuel battery cell system via the inlet side communication passage 26b or the outlet side communication passage 30b through the cathode gas passage 18b shown in FIG. 2(B). After the generation of electricity by the fuel battery cell is stopped, the water produced at the time of electricity generation by the fuel battery cell might not be drained completely out of the fuel battery cell system and may remain in the inlet side cathode gas manifold 20b or the outlet side cathode gas manifold 22b. Similarly, the water moved through the membrane-electrode assembly 10 from the cathode side to the anode side might also remain in the inlet side anode gas manifold 20a or the outlet side anode gas manifold 22a.

As shown in FIG. 1, hollow portions 32 are formed when the fuel battery cells are mutually sealed with the gaskets 16. The water remaining in the inlet side cathode gas manifold 20b or the outlet side cathode gas manifold 22b shown in FIG. 2(B) might flow out of the inlet side cathode gas manifold 20b or the outlet side cathode gas manifold 22b to remain in the hollow portions 32 (the same also applies to the inlet side anode gas manifold 20a or the outlet side anode gas manifold 22a).

Thus, when the water remains in the inlet side reaction gas manifolds (the inlet side anode gas manifold 20a and the inlet side cathode gas manifold 20b), the outlet side reaction gas manifold (the outlet side anode gas manifold 22a or the outlet side cathode gas manifold 22b), or the hollow portions 32, the members (the gasket 16 and the like) near the inlet side reaction gas manifold or the outlet side reaction gas manifold might be corroded by the water.

In addition, there is a possibility that the water remaining in the inlet side reaction gas manifold, the outlet side reaction gas manifold or the hollow portions 32 will be frozen in a below-freezing environment, and the frozen water has volume expansion to deteriorate the sealing properties of the gasket 16 for sealing between the fuel battery cells.

For example, JP-A 2006-100004 and JP-A 2006-147503 have proposed a fuel battery cell which has a drain conduit portion or a water absorbing member disposed within an inlet side reaction gas manifold or an outlet side reaction gas manifold in order to drain water remaining in the inlet side reaction gas manifold or the outlet side reaction gas manifold.

For example, JP-A 2006-66225 and JP-A 2005-259424 have proposed a fuel battery cell in which the lower surfaces of an inlet side reaction gas manifold and an outlet side reaction gas manifold are positioned to be lower than the lower surface of a communication passage in order to prevent water, that remains in the inlet side reaction gas manifold or the outlet side reaction gas manifold, from flowing back into a reaction gas passage.

For example, JP-A 2006-147467 has proposed a fuel battery cell which has the communication passage on the outlet side of the reaction gas passage inclined toward the outlet side reaction gas manifold in order to prevent water from remaining in the communication passage.

However, the fuel battery cells of JP-A 2006-100004 and JP-A 2006-147503 have a different member of a drain conduit portion or a water absorbing member disposed in the fuel cell separators, and the expansion and contraction of the different member deteriorate the sealing properties of an adhesive or the like for mutually sealing the fuel cell separators. Also, the number of parts of the fuel battery cell becomes large, and the weight of the fuel battery cell also increases.

The fuel battery cells of JP-A 2006-66225, JP-A 2005-259424 and JP-A 2006-147467 cannot drain the water remaining in the inlet side reaction gas manifold and the outlet side reaction gas manifold, so that the members near the inlet side reaction gas manifold and the outlet side reaction gas manifold are corroded, and the sealing properties of the adhesive or the like for mutually sealing the fuel cell separators are deteriorated.

### SUMMARY

The present invention relates to a fuel battery cell and a fuel cell stack that can prevent water from remaining in an inlet side or outlet side reaction gas manifold.

The present invention relates to a fuel battery cell which includes a fuel cell separator having a reaction gas passage, an inlet side reaction gas manifold in communication with an inlet portion of the reaction gas passage, and an outlet side reaction gas manifold in communication with an outlet portion of the reaction gas passage, wherein at least one of lower surfaces of the inlet side reaction gas manifold and the outlet side reaction gas manifold is inclined toward the reaction gas passage side.

The present invention also relates to a fuel battery cell which includes a fuel cell separator having a reaction gas passage, an inlet side reaction gas manifold, an outlet side reaction gas manifold, an inlet side communication passage which communicates an inlet portion of the reaction gas passage with the inlet side reaction gas manifold, and an outlet side communication passage which communicates an outlet portion of the reaction gas passage with the outlet side reaction gas manifold, wherein a lower surface of the inlet side reaction gas manifold is inclined toward the reaction gas passage, and the positions of a lower surface of an inlet portion of the reaction gas passage and a lower surface of the inlet side communication passage are equal to a lower end position of the lower surface of the inlet side reaction gas manifold inclined toward the reaction gas passage or lower than a lower end position of the lower surface of the inlet side reaction gas manifold inclined toward the reaction gas passage.

The present invention also relates to a fuel battery cell which includes a fuel cell separator having a reaction gas passage, an inlet side reaction gas manifold, an outlet side reaction gas manifold, an inlet side communication passage which communicates an inlet portion of the reaction gas passage with the inlet side reaction gas manifold, and an outlet side communication passage which communicates an outlet portion of the reaction gas passage with the outlet side reaction gas manifold, wherein a lower surface of the outlet side reaction gas manifold is inclined toward the reaction gas passage side, and the positions of a lower surface of an outlet portion of the reaction gas passage and a lower surface of the outlet side communication passage are equal to a lower end position of the lower surface of the outlet side reaction gas manifold inclined toward the reaction gas passage or lower than a lower end position of the lower surface of the outlet side reaction gas manifold inclined toward the reaction gas passage.

The present invention also relates to a fuel battery cell which includes a fuel cell separator having a reaction gas passage, an inlet side reaction gas manifold, an outlet side reaction gas manifold, an inlet side communication passage which communicates an inlet portion of the reaction gas passage with the inlet side reaction gas manifold, and an outlet side communication passage which communicates an outlet portion of the reaction gas passage with the outlet side reaction gas manifold, wherein lower surfaces of the inlet side reaction gas manifold and the outlet side reaction gas manifold are inclined toward the reaction gas passage, the positions of a lower surface of an inlet portion of the reaction gas passage and a lower surface of the inlet side communication passage are equal to a lower end position of the lower surface of the inlet side reaction gas manifold inclined toward the reaction gas passage or lower than the lower end position of the lower surface of the inlet side reaction gas manifold inclined toward the reaction gas passage, and the positions of a lower surface of an outlet portion of the reaction gas passage and a lower surface of the outlet side communication passage are equal to a lower end position of the lower surface of the outlet side reaction gas manifold inclined toward the reaction gas passage or lower than a lower end position of the lower surface of the outlet side reaction gas manifold inclined toward the reaction gas passage.

Also, the fuel cell separator of the above-described fuel battery cell preferably has a gasket.

The fuel cell stack of the invention has the above-described fuel battery cell stacked into plural layers.

The present invention can provide a fuel battery cell and a fuel cell stack in which at least one of the lower surfaces of the inlet side reaction gas manifold and the outlet side reaction gas manifold is inclined toward the reaction gas passage, so that water can be prevented from remaining in the inlet side reaction gas manifold or the outlet side reaction gas manifold.

### BRIEF DESCRIPTION OF THE DRAWINGS

Preferred embodiment(s) of the present invention will be described in detail based on the following figures, wherein:

FIG. 1 is a schematic sectional view showing an example of a structure of a general fuel battery cell,

FIG. 2(A) is a schematic top view of an anode electrode side separator 12 used for the fuel battery cell 1 shown in FIG. 1,

FIG. 2(B) is a schematic top view of a cathode electrode side separator 14 used for the fuel battery cell 1 shown in FIG. 1,

FIG. 3 is a schematic perspective view showing an example of a structure of a fuel cell stack according to an embodiment of the invention,

FIG. 4 is a schematic sectional view of the fuel cell stack 2 shown in FIG. 3,

FIG. 5 is a schematic sectional view showing an example of a structure of a fuel battery cell according to an embodiment of the invention,

FIG. 6(A) is a schematic top view showing an example of a structure of an anode electrode side separator 48 used for a fuel battery cell 3 shown in FIG. 5,

FIG. 6(B) is a schematic top view showing an example of a structure of a cathode electrode side separator 50 used for the fuel battery cell 3 shown in FIG. 5,

FIG. 7(A) is a schematic top view showing an example of another structure of the anode electrode side separator 48 used for the fuel battery cell 3 shown in FIG. 5,

FIG. 7(B) is a schematic top view showing an example of another structure of the cathode electrode side separator 50 used for the fuel battery cell 3 shown in FIG. 5,

FIG. 8(A) is a schematic top view showing an example of another structure of the anode electrode side separator 48 used for the fuel battery cell 3 shown in FIG. 5,

FIG. 8(B) is a schematic top view showing an example of another structure of the cathode electrode side separator 50 used for the fuel battery cell 3 shown in FIG. 5,

FIG. 9(A) is a schematic top view showing an example of another structure of the anode electrode side separator 48 used for the fuel battery cell 3 shown in FIG. 5,

FIG. 9(B) is a schematic top view showing an example of another structure of the cathode electrode side separator 50 used for the fuel battery cell 3 shown in FIG. 5,

FIG. 10 is a schematic sectional view showing the fuel battery cells stacked into two layers according to the embodiment, and

FIG. 11 is a schematic sectional view showing an example of a structure of the fuel battery cell according to another embodiment of the invention.

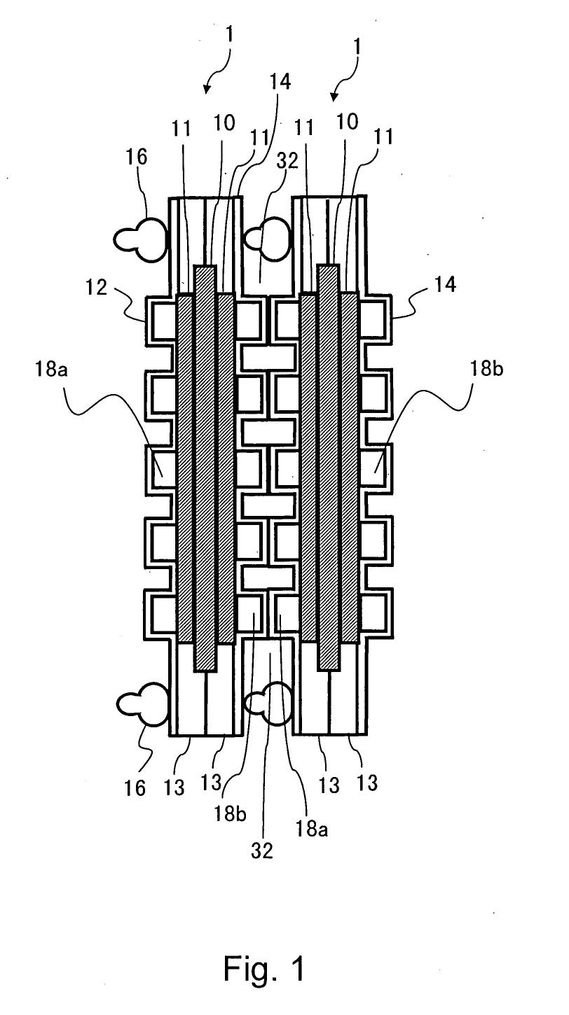

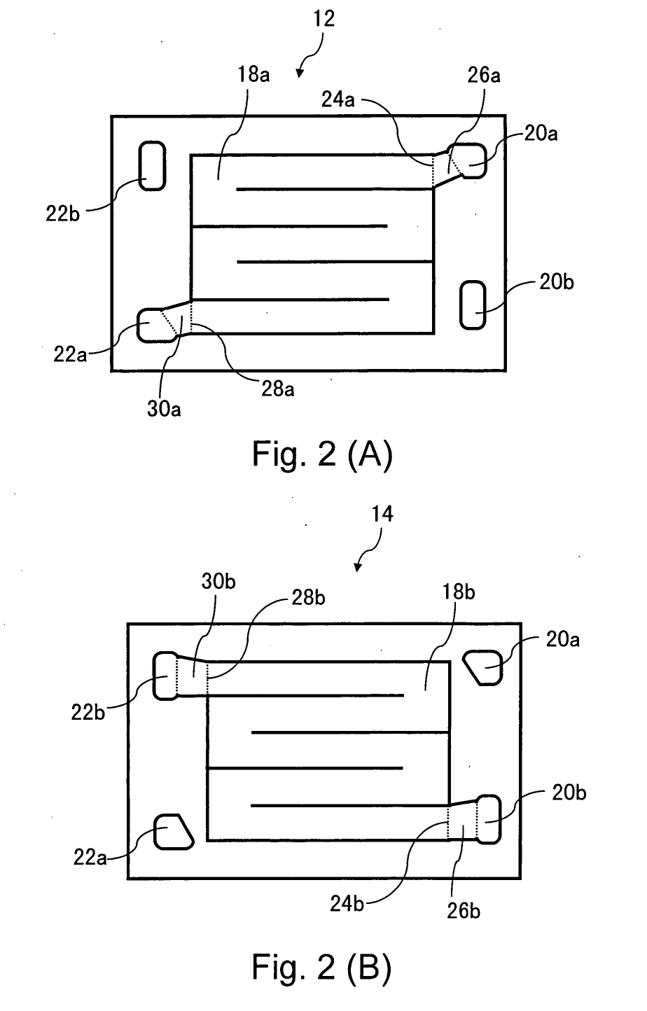

### DETAILED DESCRIPTION

Embodiments of the invention will be described below.

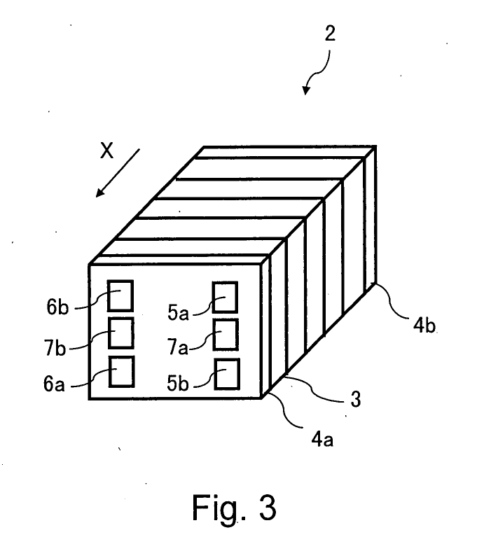

FIG. 3 is a schematic perspective view showing an example of a structure of the fuel cell stack according to the embodiment of the invention. A fuel cell stack 2 has plural fuel battery cells 3 stacked and plates 4a, 4b disposed at either end in the stacked direction (arrow X). This embodiment will be described with reference to an example of stacking the fuel battery cells 3 into five layers but the number of stacked layers is not particularly limited.

The plate 4a has an anode gas supply port 5a, an anode gas discharge port 6a, a cathode gas supply port 5b, a cathode gas discharge port 6b, a cooling water supply port 7a and a cooling water discharge port 7b. Meanwhile, the plate 4b does not have such manifolds.

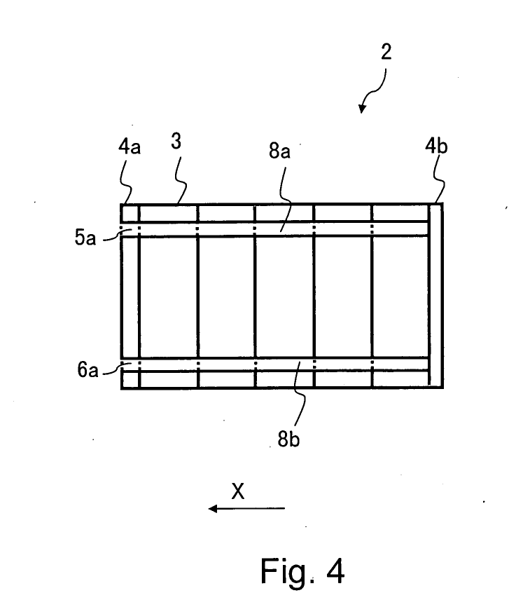

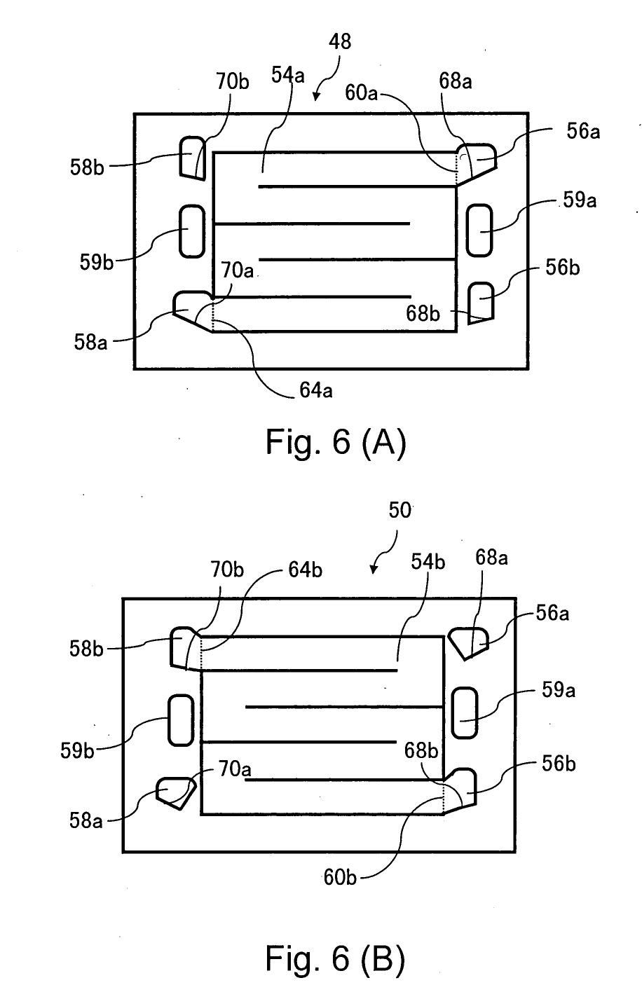

FIG. 4 is a schematic sectional view of the fuel cell stack 2 shown in FIG. 3. The fuel battery cells 3 are stacked to form a communication inlet side anode gas through manifold 8a, which communicates the inlet side anode gas manifold (shown in e.g., FIG. 6) of a fuel cell separator to be described later in the stacked direction (arrow X) of the fuel cell stack 2, and an outlet side anode gas through manifold 8b which communicates the outlet side anode gas manifold (shown in FIG. 6) in the stacked direction of the fuel cell stack 2. Similarly, the inlet side and outlet side cathode gas manifolds of the fuel cell separator to be described later also form the inlet side and outlet side cathode gas through manifolds (not shown) which communicate in the stacked direction of the fuel cell stack 2.

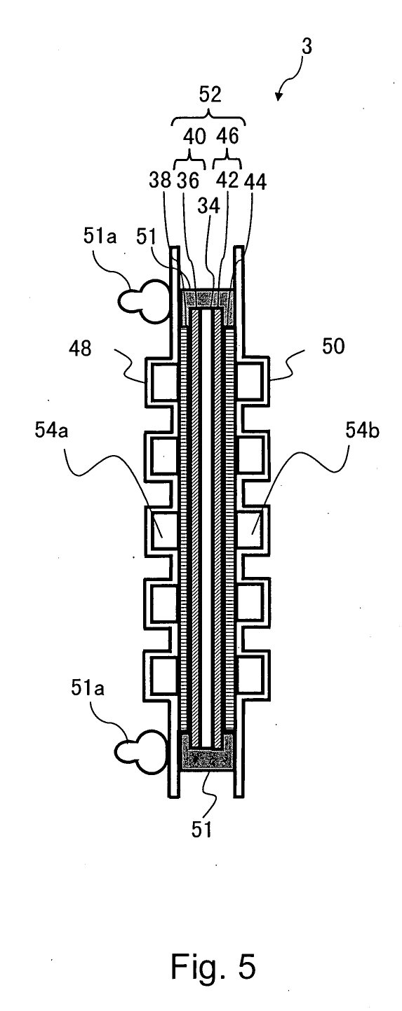

FIG. 5 is a schematic sectional view showing an example of a structure of the fuel battery cell according to the embodiment of the invention. As shown in FIG. 5, the fuel battery cell 3 has an electrolyte membrane 34, an anode electrode 40 (anode electrode catalytic layer 36), an anode electrode diffusion layer 38, a cathode electrode 46 (cathode electrode catalytic layer 42), a cathode electrode diffusion layer 44, an anode electrode side separator 48 and a cathode electrode side separator 50 as fuel cell separators, sealing materials 51 and gaskets 51a.

As shown in FIG. 5, the fuel battery cell 3 according to this embodiment has a membrane-electrode assembly 52 which is formed with the anode electrode 40 formed on one surface of the electrolyte membrane 34 and the cathode electrode 46 formed on the other surface to face each other with the electrolyte membrane 34 therebetween, and the anode electrode diffusion layer 38, the cathode electrode diffusion layer 44, the anode electrode side separator 48 and the cathode electrode side separator 50 which hold both the outer sides of the membrane-electrode assembly 52 between them. Hollow portions of the anode electrode side separator 48 and the cathode electrode side separator 50 on the side of the membrane-electrode assembly 52 become an anode gas passage 54a and a cathode gas passage 54b as reaction gas passages respectively.

FIG. 6(A) is a schematic top view showing an example of a structure of the anode electrode side separator 48 used for the fuel battery cell 3 shown in FIG. 5, and FIG. 6(B) is a schematic top view showing an example of a structure of the cathode electrode side separator 50 used for the fuel battery cell 3 shown in FIG. 5. As shown in FIGS. 6(A) and 6(B), the anode electrode side separator 48 and the cathode electrode side separator 50 each have the anode gas passage 54a or the cathode gas passage 54b as the reaction gas passage, an inlet side anode gas manifold 56a and an inlet side cathode manifold 56b as inlet side reaction gas manifolds, an outlet side anode gas manifold 58a and an outlet side cathode manifold 58b as outlet side reaction gas manifolds, an inlet side cooling water manifold 59a and an outlet side cooling water manifold 59b. As shown in FIG. 6(A), the inlet side anode gas manifold 56a of the anode electrode side separator 48 is in communication with an inlet portion 60a of the anode gas passage 54a, and the outlet side anode gas manifold 58a is in communication with an outlet portion 64a of the anode gas passage 54a. Similarly, as shown in FIG. 6(B), the inlet side cathode gas manifold 56b of the cathode electrode side separator 50 is in communication with an inlet portion 60b of the cathode gas passage 54b, and an outlet portion 64b of the cathode gas passage 54b is in communication with the outlet side cathode gas manifold 58b.

The operation of the fuel cell stack 2 is described below.

When the fuel cell stack 2 generates electricity, anode gas is supplied from the outside of the fuel cell stack 2 shown in FIGS. 3 and 4 to the individual fuel battery cells 3 through the anode gas supply port 5a of the plate 4a and the inlet side anode gas through manifold 8a.

The anode gas supplied to the fuel battery cell 3 is supplied from the inlet portion 60a of the anode gas passage 54a to the anode gas passage 54a through the inlet side anode gas manifold 56a shown in FIG. 6(A). The supplied anode gas is supplied from the anode gas passage 54a to the anode electrode diffusion layer 38 and the anode electrode catalytic layer 36 shown in FIG. 5 and used for generation of electricity by the fuel battery cell 3. Anode gas (anode exhaust gas) not used for the electricity generation is discharged from the outlet portion 64a of the anode gas passage 54a to the outside of the fuel battery cell 3 through the outlet side anode gas manifold 58a.

The discharged anode gas is discharged out of the system of the fuel cell stack 2 through the outlet side anode gas through manifold 8b, and the anode gas discharge port 6a of the plate 4a shown in FIG. 4.

Meanwhile, the cathode gas supplied from the outside of the fuel cell stack 2 shown in FIGS. 3 and 4 is also supplied to the individual fuel battery cells 3 through the cathode gas supply port 5b of the plate 4a and the inlet side cathode gas through manifold (not shown).

The cathode gas supplied to the fuel battery cell 3 is supplied to the cathode gas passage 54b via the inlet portion 60b of the cathode gas passage 54b through the inlet side cathode gas manifold 56b shown in FIG. 6(B). The supplied cathode gas is supplied to the cathode electrode diffusion layer 44 and the cathode electrode catalytic layer 42 through the cathode gas passage 54b shown in FIG. 5 and used for the electricity generation by the fuel battery cell 3. Cathode gas (cathode exhaust gas) not used for the electricity generation is discharged from the outlet portion 64b of the cathode gas passage 54b to the outside of the fuel battery cell 3 through the outlet side cathode gas manifold 58b.

The discharged cathode gas is discharged out of the system of the fuel cell stack 2 through the outlet side cathode gas through manifold (not shown) and the cathode gas discharge port 6b of the plate 4a.

A flow of water produced when electricity is generated by the fuel battery cell 3 will be described with reference to the cathode electrode side as an example.

The water produced by the cathode electrode 46 shown in FIG. 5 is drained to the cathode gas passage 54b shown in FIGS. 5 and 6(B). The water drained to the cathode gas passage 54b is drained from the inlet portion 60b and the outlet portion 64b of the cathode gas passage 54b to the outside of the fuel battery cell 3 shown in FIG. 5 through the inlet side cathode gas manifold 56b and the outlet side cathode gas manifold 58b. The water is also drained in the same manner on the side of the anode electrode 40.

As described above, the reaction gas (anode gas, cathode gas) flows from the inlet portion of the reaction gas passage of the fuel cell separator to the outlet portion, so that the water produced in electricity generation is easily drained, together with the reaction gas from the outlet side reaction gas manifolds (the outlet side anode gas manifold 58a and the outlet side cathode gas manifold 58b), to the outside of the fuel battery cell 3.

The anode electrode side separator and the cathode electrode side separator used for the fuel battery cell according to this embodiment have at least one of a lower surface 68a of the inlet side anode gas manifold 56a, a lower surface 68b of the inlet side cathode gas manifold 56b, a lower surface 70a of the outlet side anode gas manifold 58a and a lower surface 70b of the outlet side cathode gas manifold 58b inclined toward the anode gas passage 54a and the cathode gas passage 54b. Here, the lower surface means a surface of a lower part, which is opposite to a direction of gravitational force, of the circumferential surfaces of the inlet side and outlet side reaction gas manifolds.

As described above, the lower surfaces of the inlet side and outlet side reaction gas manifolds are inclined toward the reaction gas passage, so that the water in the inlet side reaction gas manifolds (the inlet side anode gas manifold 56a and the inlet side cathode gas manifold 56b) or the outlet side reaction gas manifolds (the outlet side anode gas manifold 58a and the outlet side cathode gas manifold 58b) can be made to flow to the reaction gas passages (the anode gas passage 54a and the cathode gas passage 54b). Therefore, the water can be prevented from remaining in the inlet side reaction gas manifold or the outlet side reaction gas manifold.

As described above, the reaction gas flows from the inlet portion to the outlet portion of the reaction gas passage. Also, the water produced when the fuel battery cell generates electricity is easily drained together with reaction gas, which flows from the inlet portion to the outlet portion, from the outlet side reaction gas manifold. Therefore, the water tends to remain in the outlet side reaction gas manifold. Accordingly, the anode electrode side separator and the cathode electrode side separator, which are used for the fuel battery cell according to this embodiment, are desired to have at least the lower surface 70a of the outlet side anode gas manifold 58a and the lower surface 70b of the outlet side cathode gas manifold 58b inclined toward the anode gas passage 54a and the cathode gas passage 54b.

In addition, the water remaining in the inlet side and outlet side reaction gas manifolds is not limited to the water produced when the fuel battery cell generates electricity as described above. For example, dew condensation is caused in the inlet side and outlet side reaction gas manifolds in a low temperature environment, possibly remaining as condensed water in the inlet side and outlet side reaction gas manifolds. Therefore, the anode electrode side separator 48 and the cathode electrode side separator 50 are desired that the lower surface 68a of the inlet side anode gas manifold 56a, the lower surface 68b of the inlet side cathode gas manifold 56b, the lower surface 70a of the outlet side anode gas manifold 58a and the lower surface 70b of the outlet side cathode gas manifold 58b are inclined toward the anode gas passage 54a and the cathode gas passage 54b as shown in FIGS. 6(A) and 6(B).

The inclination of the lower surfaces (68a, 68b, 70a, 70b) is not particularly limited as long as it is set to drain the water, which is in the inlet side and outlet side reaction gas manifolds, to the reaction gas passage side.

As described above, the members (e.g., the sealing materials 51, the gaskets 51a and the like shown in FIG. 5) near the inlet side and outlet side reaction gas manifolds can be prevented from being corroded by causing the water, which is in the inlet side and outlet side reaction gas manifolds, to flow to the reaction gas passage side to prevent the water from remaining in the inlet side and outlet side reaction gas manifolds.

Meanwhile, the members near the reaction gas passage interior are substantially not corroded by the water that is made to flow into the reaction gas passage. This is because the reaction gas passage is close to the cooling water passage (not shown) and the electrodes, so that the reaction gas passage interior has a relatively high temperature (e.g., 60 degrees C. to 85 degrees C.), and the water in the reaction gas passage is substantially volatilized.

An example of another structure of the fuel cell separator used for the fuel battery cell according to this embodiment will now be described below.

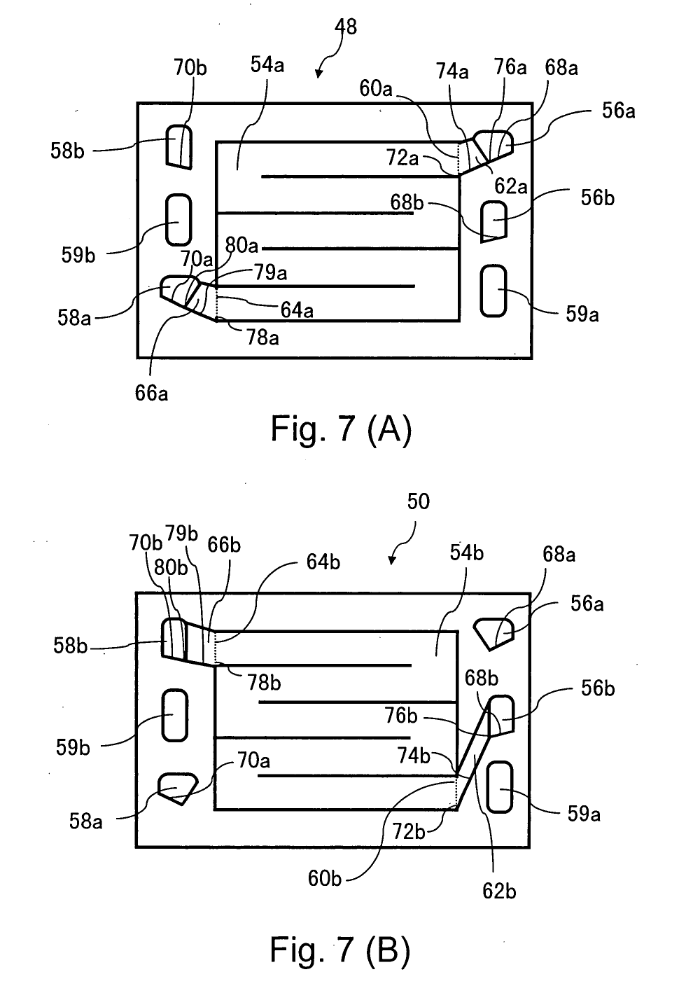

FIG. 7(A) is a schematic top view showing an example of another structure of the anode electrode side separator 48 used for the fuel battery cell 3 shown in FIG. 5. FIG. 7(B) is a schematic top view showing an example of another structure of the cathode electrode side separator 50 used for the fuel battery cell 3 shown in FIG. 5. As shown in FIG. 7(A), the anode electrode side separator 48 has an inlet side communication passage 62a which communicates the inlet portion 60a of the anode gas passage 54a with the inlet side anode gas manifold 56a, and an outlet side communication passage 66a which communicates the outlet portion 64a of the anode gas passage 54a with the outlet side anode gas manifold 58a. Similarly, as shown in FIG. 7(B), the cathode electrode side separator 50 has an inlet side communication passage 62b which communicates the inlet portion 60b of the cathode gas passage 54b with the inlet side cathode gas manifold 56b and an outlet side communication passage 66b which communicates the outlet portion 64b of the cathode gas passage 54b with the outlet side cathode gas manifold 58b.

The arrangements of the inlet side and outlet side anode gas manifolds 56a, 58a, the inlet side and outlet side cathode gas manifolds 56b, 58b, and the inlet side and outlet side cooling water manifolds 59a, 59b are not particularly limited, but the inlet side cooling water manifold 59a is desirably disposed at the lowest position as shown in FIGS. 7(A) and 7(B) because a disadvantage due to air bubbles mixed into the refrigerant can be prevented.

As described above, the water produced when the fuel battery cell generates electricity tends to be drained together with the reaction gas from the outlet side reaction gas manifold, so that it tends to remain in the outlet side reaction gas manifold. Also, condensed water tends to remain not only in the outlet side reaction gas manifold but also in the inlet side reaction gas manifold in a low temperature environment.

For example, in a case where the water tends to remain in the inlet side reaction gas manifold and the outlet side reaction gas manifold, it is desirable for the anode electrode side separator 48 and the cathode electrode side separator 50 to have the lower surface 68a of the inlet side anode gas manifold 56a, the lower surface 68b of the inlet side cathode gas manifold 56b, the lower surface 70a of the outlet side anode gas manifold 58a, and the lower surface 70b of the outlet side cathode gas manifold 58b inclined toward the anode gas passage 54a and the cathode gas passage 54b as shown in FIGS. 7(A) and 7(B). As shown in FIG. 7(A), it desirable with respect to the anode electrode side separator 48 that a lower surface 72a of the inlet portion 60a of the reaction gas passage 54a and a lower surface 74a of the inlet side communication passage 62a are lower than (or may be equal to) a lower end position 76a of the lower surface 68a of the inlet side anode gas manifold 56a, and a lower surface 78a of the outlet portion 64a of the reaction gas passage 54a and a lower surface 79a of the outlet side communication passage 66a are lower than (or may be equal to) a lower end position 80a of the lower surface 70a of the outlet side anode gas manifold 58a. As shown in FIG. 7(B), for the cathode electrode side separator 50, it is desirable that a lower surface 72b of the inlet portion 60b of the reaction gas passage 54b and a lower surface 74b of the inlet side communication passage 62b are lower than (or may be equal to) a lower end position 76b of the lower surface 68b of the inlet side cathode gas manifold 56b, and a lower surface 78b of the outlet portion 64b of the reaction gas passage 54b and a lower surface 79b of the outlet side communication passage 66b are lower than (or may be equal to) a lower end position 80b of the lower surface 70b of the outlet side cathode gas manifold 58b.

Here, the lower end positions (76a, 76b) of the lower surfaces of the inlet side reaction gas manifolds indicate the lowest positions among the lower surfaces of the inlet side reaction gas manifolds described above. The lower end positions (80a, 80b) of the lower surfaces of the outlet side reaction gas manifolds also indicate the lowest positions among the lower surfaces of the outlet side reaction gas manifolds described above. Also, the lower surfaces (72a, 72b) of the inlet portions (60a, 60b) of the reaction gas passages indicate lower surfaces opposed to a direction of the gravitational force among the inlet portions. The lower surfaces (78a, 78b) of the outlet portions (64a, 64b) of the reaction gas passages also indicate the lower surfaces opposed to the direction of the gravitational force among the outlet portions. In addition, the lower surfaces (74a, 74b) of the inlet side communication passages (62a, 62b) indicate lower surfaces opposed to the direction of the gravitational force among the inlet side communication passages. The lower surfaces (79a, 79b) of the outlet side communication passages (66a, 66b) also indicate lower surfaces opposed to the direction of the gravitational force among the outlet side communication passages.

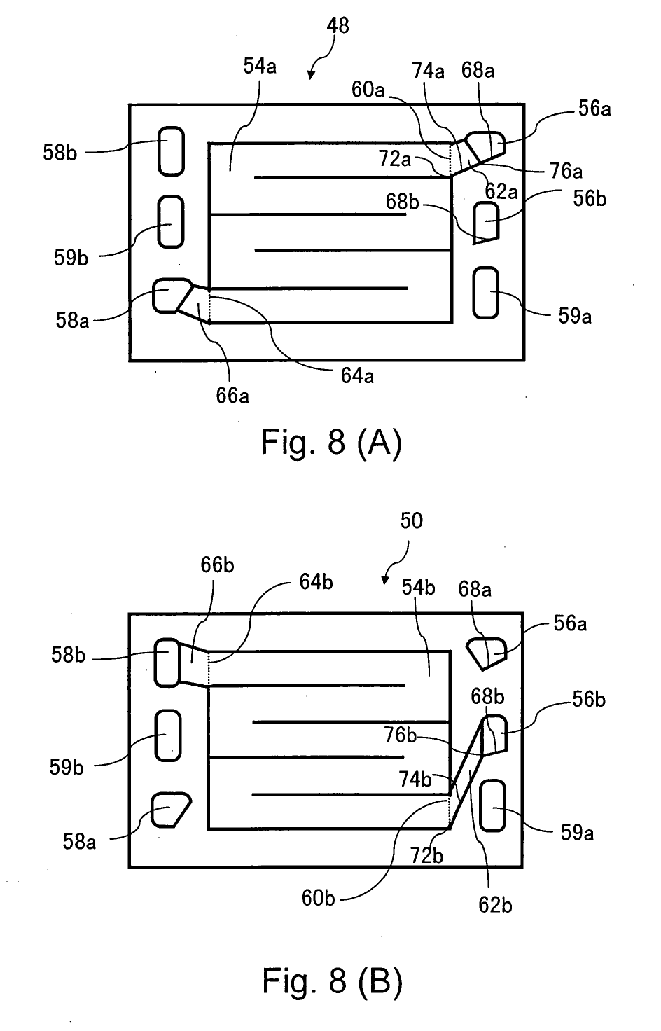

FIG. 8(A) is a schematic top view showing an example of another structure of the anode electrode side separator 48 used for the fuel battery cell 3 shown in FIG. 5, and FIG. 8(B) is a schematic top view showing an example of another structure of the cathode electrode side separator 50 used for the fuel battery cell 3 shown in FIG. 5. For example, if water tends to remain in the inlet side reaction gas manifold, it is desirable, with respect to the anode electrode side separator 48 and the cathode electrode side separator 50, for the lower surface 68a of the inlet side anode gas manifold 56a and the lower surface 68b of the inlet side cathode gas manifold 56b to be inclined toward the anode gas passage 54a and the cathode gas passage 54b as shown in FIGS. 8(A) and 8(B). As shown in FIG. 8(A), it is desired, with respect to the anode electrode side separator 48, that the lower surface 72a of the inlet portion 60a of the reaction gas passage 54a and the lower surface 74a of the inlet side communication passage 62a are lower than (or may be equal to) the lower end position 76a of the lower surface 68a of the inlet side anode gas manifold 56a. It is also desirable, with respect to the cathode electrode side separator 50, for the lower surface 72b of the inlet portion 60b of the reaction gas passage 54b and the lower surface 74b of the inlet side communication passage 62b to be lower than (or may be equal to) the lower end position 76b of the lower surface 68b of the inlet side cathode gas manifold 56b as shown in FIG. 8(B).

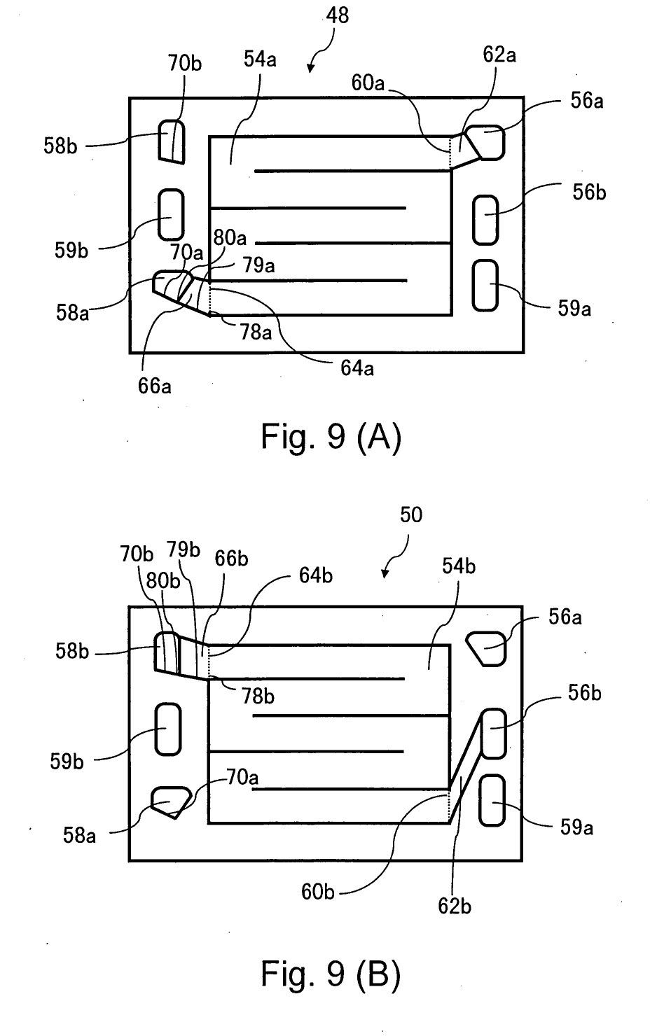

FIG. 9(A) is a schematic top view showing an example of another structure of the anode electrode side separator 48 used for the fuel battery cell 3 shown in FIG. 5, and FIG. 9(B) is a schematic top view showing an example of another structure of the cathode electrode side separator 50 used for the fuel battery cell 3 shown in FIG. 5. For example, if the water tends to remain in the outlet side reaction gas manifold, it is desirable, for the anode electrode side separator 48 and the cathode electrode side separator 50, for the lower surface 70a of the outlet side anode gas manifold 58a and the lower surface 70b of the outlet side cathode gas manifold 58b to be inclined toward the anode gas passage 54a and the cathode gas passage 54b as shown in FIGS. 9(A) and 9(B). As shown in FIG. 9(A), it is desirable, with the anode electrode side separator 48 is desired, for the lower surface 78a of the outlet portion 64a of the reaction gas passage 54a and the lower surface 79a of the outlet side communication passage 66a to be lower than (or may be equal to) the lower end position 80a of the lower surface 70a of the outlet side anode gas manifold 58a. Also, with respect to the cathode electrode side separator 50, it is desired that the lower surface 78b of the outlet portion 64b of the reaction gas passage 54b and the lower surface 79b of the outlet side communication passage 66b are lower than (or may be equal to) the lower end position 80b of the lower surface 70b of the outlet side cathode gas manifold 58b as shown in FIG. 9(B).

Thus, the lower surfaces of the inlet portion and the outlet portion of the reaction gas passage, the inlet side communication passage and the outlet side communication passage are made equal to or lower than the lower ends of the lower surfaces of the inlet side reaction gas manifold and the outlet side reaction gas manifold, so that the water in the inlet side and outlet side reaction gas manifolds is made to flow to the reaction gas passage, and the water in the inlet side and outlet side reaction gas manifolds can be prevented from remaining therein. Also, the water can be prevented from remaining in the inlet side and outlet side reaction gas manifolds to prevent the members (e.g., the sealing materials 51, the gaskets 51a and the like shown in FIG. 5) near the inlet side and outlet side reaction gas manifolds from being corroded.

The sealing materials 51 shown in FIG. 5 are to seal between the anode electrode side separator 48 and the cathode electrode side separator 50, and an adhesive or the like is used for that. The gaskets 51a are to seal the mutually adjacent fuel battery cells and the like, and a rubber sealing material such as silicone rubber, fluororubber or the like is used.

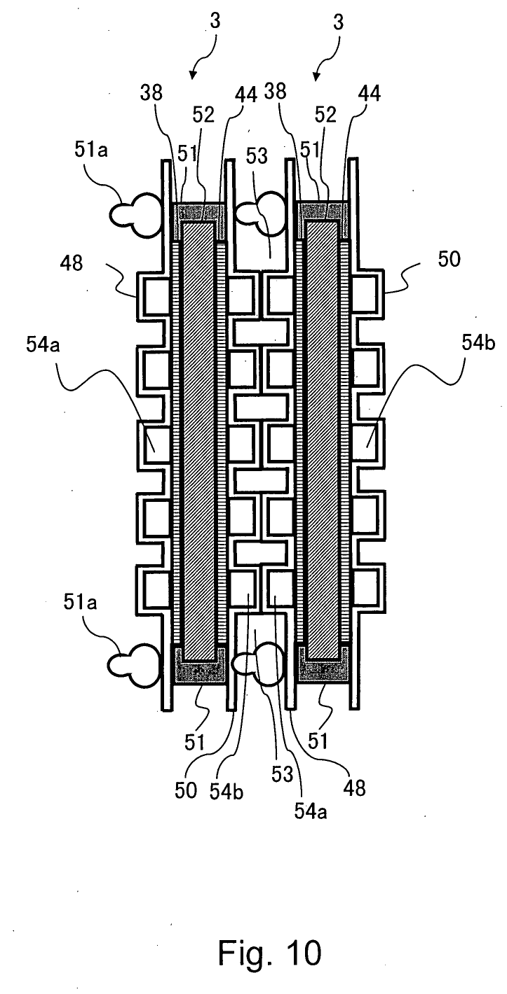

FIG. 10 is a schematic sectional view showing the fuel battery cells stacked into two layers according to this embodiment. As shown in FIG. 10, in a case where the gaskets 51a are used to seal the fuel battery cells mutually, space portions 53 are possibly formed. As described above, when the water in the inlet side and outlet side reaction gas manifolds flows out of them, it might remain in the space portions 53. The gaskets 51a may be corroded by the water remaining in the space portions 53. Also, the water remaining in the space portions 53 may be frozen in a low temperature environment, and the sealing properties of the gaskets 51a might be deteriorated by the volume expansion of the frozen water.

The gaskets 51a are desirable in view of workability of mutually sealing the fuel battery cells but have disadvantages in view of corrosion resistance and the like. However, the fuel cell separators (FIGS. 6 to 9) used in this embodiment can prevent water from remaining in the inlet side and outlet side reaction gas manifolds, so that the corrosion resistance and the like of the gaskets 51a can be prevented from being deteriorated.

As described above, the reaction gas passage interior has a relatively high temperature (e.g., 60 degrees C. to 85 degrees C.), so that the water that has been made to flow into the reaction gas passage is hardly frozen even in the low temperature environment. Even if the water is frozen in the reaction gas passage, the water frozen in the reaction gas passage is melted relatively easily by the heat generation of the cooling water flowing through a cooling water passage (not shown) and the fuel battery cell itself when the fuel battery cell generates electricity.

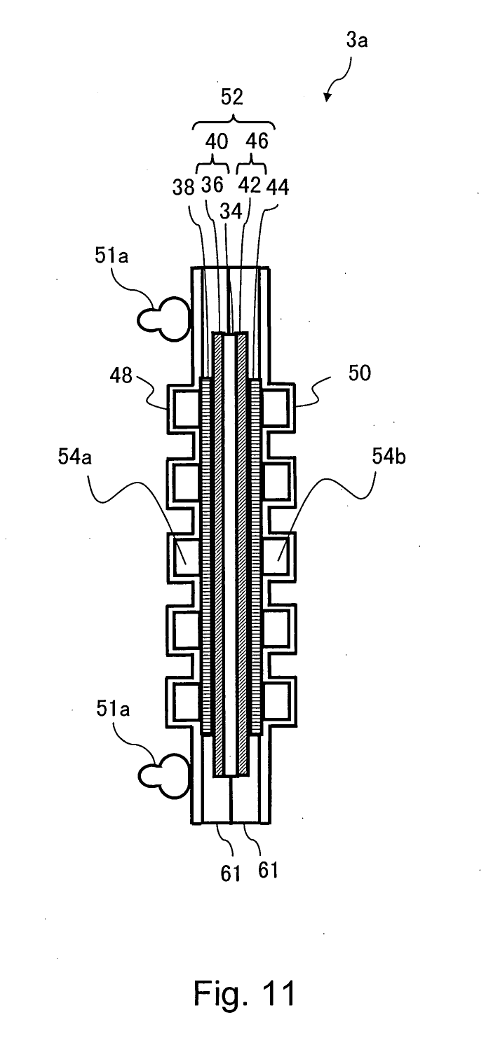

FIG. 11 is a schematic sectional view showing an example of a structure of the fuel battery cell according to another embodiment of the invention. As shown in FIG. 11, a fuel battery cell 3a has the anode electrode diffusion layer 38 and the cathode electrode diffusion layer 44 which hold the membrane-electrode assembly 52 therebetween, the anode electrode side separator 48 and the cathode electrode side separator 50 which hold the anode electrode diffusion layer 38 and the cathode electrode diffusion layer 44 therebetween via resin frames 61, and the gaskets 51a which seal the mutually adjacent fuel battery cells. Also, a sealing material (not shown) such as the above-described adhesive or the like is used to seal between the resin frames 61, between the resin frame 61 and the anode electrode side separator 48 and between the resin frame 61 and the cathode electrode side separator 50. The members common to those of the fuel battery cell 3 shown in FIG. 5 are denoted by like reference numerals for the fuel battery cell 3a shown in FIG. 11.

The anode electrode side separator 48 and the cathode electrode side separator 50 used in this embodiment may be metal type separators, carbon type separators or the like and are not limited to a particular material.

The anode electrode diffusion layer 38 and the cathode electrode diffusion layer 44 used in this embodiment may be made of any material having high diffusivity of reaction gas and are not limited to a particular material. For example, porous carbon materials such as carbon cloth, carbon paper and the like can be used.

The anode electrode side catalytic layer 36 and the cathode electrode side catalytic layer 42 are each formed as films on the anode electrode side diffusion layer 38 and the cathode electrode side diffusion layer 44 or the electrolyte membrane 34 by mixing, for example, carbon having supported a metal catalyst such as platinum, ruthenium or the like with a perfluorosulfonic acid based electrolyte or the like. For the above-described carbon, carbon black such as acetylene black, furnace black, channel black, thermal black or the like is used.

The electrolyte membrane 34 used in this embodiment is not limited to a particular one as long as it does not have electron transferability but has proton conductivity. For example, it is a perfluorosulfonic acid type resin film, a copolymer film of a trifluorostyrene derivative, a polybenzimidazole film impregnated with phosphoric acid, an aromatic polyether ketone sulphonic acid film, or the like. A specific example is Nafion (registered trademark).

The fuel cell stack and the fuel battery cell according to this embodiment produced as described above can prevent water from remaining in the reaction gas manifolds by inclining the reaction gas manifolds of the fuel cell separators toward the reaction gas passages. The members near the reaction gas manifolds can be prevented from being corroded by preventing water from remaining in the reaction gas manifolds. In addition, the sealing properties of the sealing material (gasket) can be prevented from being deteriorated due to the volume expansion of water frozen resulting from freezing of the water in the reaction gas manifolds in a low temperature environment.

The fuel battery cell and the fuel cell stack according to the above-described embodiments can be used as, for example, a compact power supply for mobile devices, such as a cellular phone, a portable personal computer and the like, and an automotive power supply, a domestic power supply and the like.

What is claimed is:

1. A fuel battery cell which includes a fuel cell separator having a reaction gas passage, an inlet side reaction gas manifold in communication with an inlet portion of the reaction gas passage, and an outlet side reaction gas manifold in communication with an outlet portion of the reaction gas passage, wherein:
at least one of lower surfaces of the inlet side reaction gas manifold and the outlet side reaction gas manifold is inclined toward the reaction gas passage.

2. A fuel battery cell which includes a fuel cell separator having a reaction gas passage, an inlet side reaction gas manifold, an outlet side reaction gas manifold, an inlet side communication passage which communicates an inlet portion of the reaction gas passage with the inlet side reaction gas manifold, and an outlet side communication passage which communicates an outlet portion of the reaction gas passage with the outlet side reaction gas manifold, wherein:
a lower surface of the inlet side reaction gas manifold is inclined toward the reaction gas passage, and
the positions of a lower surface of an inlet portion of the reaction gas passage and a lower surface of the inlet side communication passage are equal to a lower end position of the lower surface of the inlet side reaction gas manifold inclined toward the reaction gas passage or lower than a lower end position of the lower surface of the inlet side reaction gas manifold inclined toward the reaction gas passage.

3. A fuel battery cell which includes a fuel cell separator having a reaction gas passage, an inlet side reaction gas manifold, an outlet side reaction gas manifold, an inlet side communication passage which communicates an inlet portion of the reaction gas passage with the inlet side reaction gas manifold, and an outlet side communication passage which communicates an outlet portion of the reaction gas passage with the outlet side reaction gas manifold, wherein:
a lower surface of the outlet side reaction gas manifold is inclined toward the reaction gas passage, and
the positions of a lower surface of an outlet portion of the reaction gas passage and a lower surface of the outlet side communication passage are equal to a lower end position of the lower surface of the outlet side reaction gas manifold inclined toward the reaction gas passage or lower than a lower end position of the lower surface of the outlet side reaction gas manifold inclined toward the reaction gas passage.

4. A fuel battery cell which includes a fuel cell separator having a reaction gas passage, an inlet side reaction gas manifold, an outlet side reaction gas manifold, an inlet side communication passage which communicates an inlet portion of the reaction gas passage with the inlet side reaction gas manifold, and an outlet side communication passage which communicates an outlet portion of the reaction gas passage with the outlet side reaction gas manifold, wherein:
lower surfaces of the inlet side reaction gas manifold and the outlet side reaction gas manifold are inclined toward the reaction gas passage,
the positions of a lower surface of an inlet portion of the reaction gas passage and a lower surface of the inlet side communication passage are equal to a lower end position of the lower surface of the inlet side reaction gas manifold inclined toward the reaction gas passage or lower than the lower end position of the lower surface of the inlet side reaction gas manifold inclined toward the reaction gas passage, and
the positions of a lower surface of an outlet portion of the reaction gas passage and a lower surface of the outlet side communication passage are equal to a lower end position of the lower surface of the outlet side reaction gas manifold inclined toward the reaction gas passage or lower than a lower end position of the lower surface of the outlet side reaction gas manifold inclined toward the reaction gas passage.

5. The fuel battery cell according to claim 1, wherein the fuel cell separator has a gasket.

6. The fuel battery cell according to claim 2, wherein the fuel cell separator has a gasket.

7. The fuel battery cell according to claim 3, wherein the fuel cell separator has a gasket.

8. The fuel battery cell according to claim 4, wherein the fuel cell separator has a gasket.

9. A fuel cell stack having the fuel battery cell according to claim 1 stacked into a plurality of layers.

10. A fuel cell stack having the fuel battery cell according to claim 2 stacked into a plurality of layers.

11. A fuel cell stack having the fuel battery cell according to claim 3 stacked into a plurality of layers.

12. A fuel cell stack having the fuel battery cell according to claim 4 stacked into a plurality of layers.

13. A fuel cell stack having the fuel battery cell according to claim 5 stacked into a plurality of layers.

14. A fuel cell stack having the fuel battery cell according to claim 6 stacked into a plurality of layers.

15. A fuel cell stack having the fuel battery cell according to claim 7 stacked into a plurality of layers.

16. A fuel cell stack having the fuel battery cell according to claim 8 stacked into a plurality of layers.
